(19) United States
(12) Patent Application Publication
(10) Pub. No.: US 2012/0140590 A1
(43) Pub. Date: Jun. 7, 2012

(54) Gravity Fed Beverage Dispenser

(75) Inventor: Jonathan Kirschner, Powder Springs, GA (US)

(73) Assignee: THE COCA-COLA COMPANY, Atlanta, GA (US)

(21) Appl. No.: 12/958,529

(22) Filed: Dec. 2, 2010

(51) Int. Cl. B67D 7/74; G05D 11/02

(52) U.S. Cl. 366/152.2; 222/129.4

(57) ABSTRACT

The present application provides a dispensing system for mixing a first fluid and a second fluid. The dispensing system may include a first fluid source with the first fluid therein, a volumetric dosing chamber in communication with the first fluid source, a vent tube extending from within the volumetric dosing chamber to about the first fluid source such that a dose of the first fluid from the first fluid source flows into the volumetric dosing chamber under the force of gravity until the first fluid reaches the vent tube, a first fluid dispensing line in communication with the volumetric dosing chamber, a second fluid source with the second fluid therein, and a second fluid dispensing line in communication with the second fluid source. The dose of the first fluid may flow through the first fluid dispensing line and the second fluid may flow through the second fluid dispensing line.

### TECHNICAL FIELD

The present application relates generally to beverage dispensers and other types of fluid dispensers and more particularly relates to a gravity fed fluid dispenser using hydraulic volume controls and techniques to provide a low cost but highly accurate dispenser.

### BACKGROUND OF THE INVENTION

Modern beverage dispensers generally involve the use of a number of pumps and/or other types of flow control devices to provide an accurate volume and ratio of diluent, concentrates or syrups, and other types of additives to provide a desired beverage or other type of mixture. These pumps or other devices generally are operated by a programmable electronic controller and the like. The programmable electronic controller may operate the appropriate pumps or other devices for the appropriate length of time, the appropriate volume, and/or the appropriate sequence based upon feedback from a number of sensors and the like to produce the desired beverage or other type of mixture.

These types of electronic controls, however, may be somewhat sophisticated and expensive to install and maintain. Moreover, the pumps and other types of flow control devices may tend to drift over time such that regular recalibration may be required. The pumps and other types of devices in the fluid streams also need regular cleaning and sanitization.

There is therefore a desire for a simplified dispensing system for beverages and other types of fluids. Such a simplified dispensing system preferably may provide accurate proportions of the various fluid components without complex controls and sensors.

### SUMMARY OF THE INVENTION

The present application thus provides a dispensing system for mixing a first fluid and a second fluid. The dispensing system may include a first fluid source with the first fluid therein, a volumetric dosing chamber in communication with the first fluid source, a vent tube extending from within the volumetric dosing chamber to about the first fluid source such that a dose of the first fluid from the first fluid source flows into the volumetric dosing chamber under the force of gravity until the first fluid reaches the vent tube, a first fluid dispensing line in communication with the volumetric dosing chamber, a second fluid source with the second fluid therein, and a second fluid dispensing line in communication with the second fluid source. The dose of the first fluid may flow through the first fluid dispensing line and the second fluid may flow through the second fluid dispensing line.

The present application further provides a method of mixing a first fluid and a second fluid under the force of gravity. The method may include the steps of flowing a dose of the first fluid into a volumetric dosing chamber under the force of gravity until the first fluid reaches a vent tube therein, flowing a volume of the second fluid into a fluid tank under the force of gravity until the second fluid reaches a top bend of a siphon therein, flowing the dose of the first fluid through a first fluid line under the force of gravity into a receptacle, and flowing the volume of the second fluid through the siphon under the force of gravity into the receptacle.

The present application further provides a dispensing system for mixing a concentrate and a diluent. The dispensing system may include a concentrate source with concentrate therein, a volumetric dosing chamber in communication with the concentrate source, a vent tube extending from within the volumetric dosing chamber to about the concentrate source such that a dose of the concentrate from the concentrate source flows into the volumetric dosing chamber under the force of gravity until the concentrate reaches the vent tube, a concentrate dispensing line in communication with the volumetric dosing chamber, a diluent tank with a volume of the diluent therein, and a siphon in communication with the diluent tank. The dose of the concentrate may flow through the concentrate dispensing line and the volume of the diluent may flow through the siphon.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a dispensing system as may be described herein.

FIG. 2 is a schematic view of a water control subsystem as may be used in the dispensing system of FIG. 1.

### DETAILED DESCRIPTION

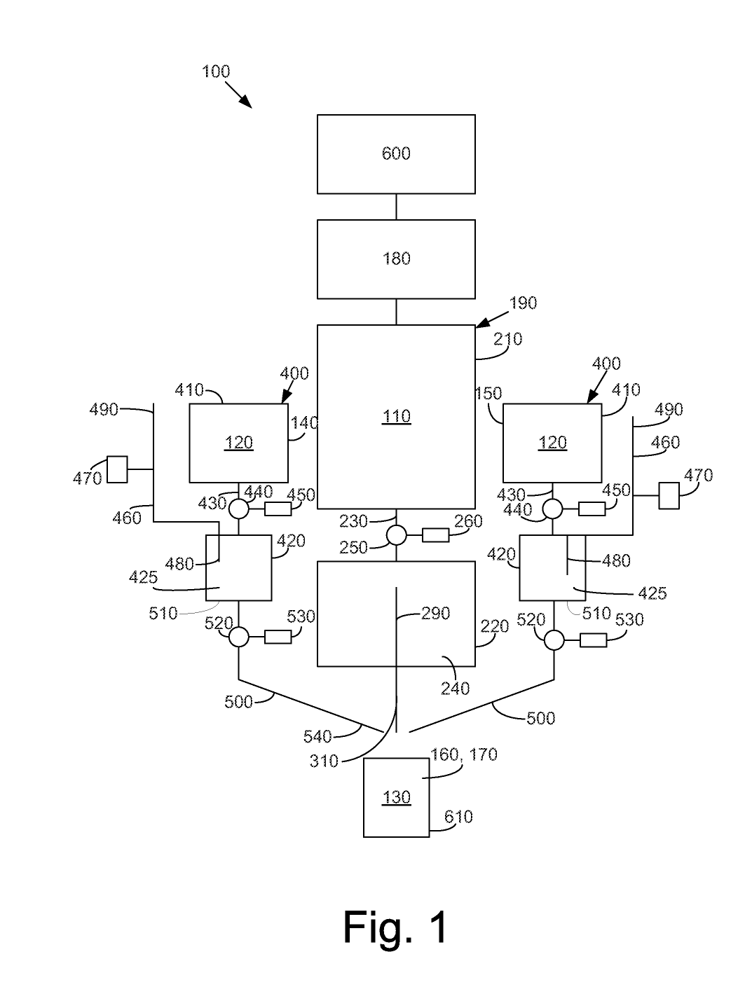

Referring now to the drawings, where like numerals refer to like elements throughout the several views, FIG. 1 shows a dispensing system 100 as may be described herein. Generally described, the dispensing system 100 may combine one or more diluents 110 with one or more concentrates 120 or other types of additives to provide a beverage 130 or other type of mixture. The diluents 110 may include water, milk, or any other type of fluid. The diluent 110 may be at any temperature and may be carbonated or still. The concentrates 120 may be any type of fluid or other substance that may be reconstituted with the diluent 110. The concentrates 120 may have any reconstitution ratio or other characteristic. Additives concerning color, smell, taste, sweetness, and other characteristics also may be used. By way of example only, the concentrates 120 may include a coffee concentrate 140 and/or a tea concentrate 150. The beverage 130 thus may be any combination of the diluents 110, the concentrates 120, and other ingredients so as to form the mixture. In this example, the beverage 130 may be a coffee 160 or a tea 170. Any type of beverage or other mixture may be used herein.

The dispensing system 100 described herein may have a number of subsystems as will be described in more detail below. Operation of the dispensing system 100 as a whole and the individual subsystems may be controlled by one or more electronic programmable controllers 180. Any type of electronic programmable control device may be used herein with any conventional type of programming language and the like.

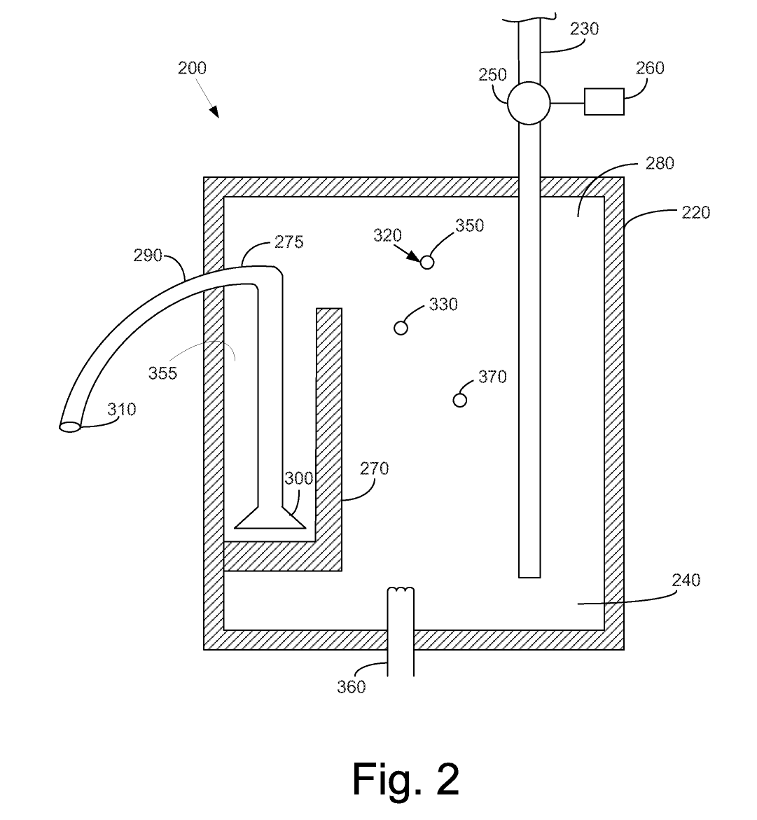

FIG. 2 shows a diluent control subsystem 200 of the dispensing system 100. The diluent control subsystem 200 controls the delivery of the diluent 110 to produce the beverage 130. The diluent control subsystem 200 may include a diluent source 210. The diluent source 210 may be a conventional tap water supply, a replaceable diluent supply such as a water bottle or a milk bottle and the like, or a refillable diluent supply such as a water carafe and the like. Any type or configuration of the diluent source 210 may be used herein.

The diluent control subsystem 200 also may include a diluent tank 220. The diluent tank 220 may have any desired size, shape, or volume. The diluent tank 220 preferably may be at atmospheric pressure. The diluent source 210 may be in communication with the diluent tank 220 via an incoming diluent line 230. The incoming diluent line 230 may extend from the diluent source 210 to about a bottom 240 of the diluent tank 220. The incoming diluent line 230 may be any type of conduit. A diluent valve 250 may be positioned on the incoming diluent line 230. The diluent valve 250 may be any type of open and close valve. The diluent valve 250 may be operated by a solenoid 260 or other type of actuating device. The solenoid 260 may be in communication with the controller 180. Other configurations and other components may be used herein.

The diluent tank 220 may include a dispensing compartment 270 therein. The dispensing compartment 270 may be a distinct section within the diluent tank 220. The dispensing compartment 270 may extend from the bottom of the diluent tank 270 to partially towards a top 280 thereof. The dispensing compartment 270 may be open about the top 280 of the diluent tank 220. The dispensing compartment 270 may have any desired size, shape, or volume.

The diluent tank 220 may include a siphon 290 positioned within the dispensing compartment 270. The siphon 290 may extend from within the dispensing compartment 270 to a top bend 275 about the top 280 of the diluent tank 220 and then may extend out of the diluent tank 220. The siphon 290 may extend from a large diameter suction bell 300 within the dispensing compartment 270 to a dispensing end 310 outside of the diluent tank 220. The siphon 290 may be any type of conduit and may have any desired size, shape, or volume. Other configurations and other components may be used herein.

A number of level sensors 320 may be positioned within the diluent tank 220. A charged or a first sensor 330 may be positioned just below the top bend 275 of the siphon 290. A dispensing or a second sensor 350 may be positioned just above the top bend 275 of the siphon 290. The level sensors 320 may be conventional connectivity sensors and the like so as to detect the level of diluent 110 within the diluent tank 220. The level sensors 320 may be in communication with the controller 180. Other configurations and other components may be used herein.

An immersion heater 360 may be positioned within the diluent tank 220 about the bottom 240 thereof. The temperature of the diluent 110 within the diluent tank 220 may be controlled by a thermocouple 370 positioned within the diluent tank 220. The immersion heater 360 and the thermocouple 370 may maintain the diluent 110 within the diluent tank 220 at a relatively constant temperature. The immersion heater 360 and the thermocouple 370 may be in communication with the controller 180. Other configurations and other components may be used herein.

The diluent control subsystem 220 efficiently and repeatedly provides a known volume of the diluent 110 to produce the final beverage 130. The controller 180 opens the diluent valve 250 about the diluent source 210 such that the diluent 110 fills the diluent tank 220 via the incoming diluent line 230. The controller 180 shuts the diluent valve 250 via the solenoid 260 once the diluent level reaches the first sensor 330. The diluent 110 therein may be heated via the immersion heater 360 to the desired temperature as monitored by the thermocouple 370.

When a volume of the diluent 110 is requested, the controller 180 again opens the diluent valve 250 via the solenoid 260. The diluent 110 thus flows within the diluent tank 220 over the first sensor 330 and into the dispensing compartment 270. When the diluent 110 within the dispensing compartment 270 and the overall diluent tank 220 reaches the second sensor 350, the controller 180 again turns off the diluent valve 250 via the solenoid 260. At about the level of the second sensor 350, the diluent 110 within the siphon 290 reaches the top bend 275 thereof such that a given volume 355 of the diluent 110 within the dispensing compartment 270 flows out of the dispensing end 310 of the siphon 290 under the force of gravity. The given volume 355 of the diluent 110 within the dispensing compartment 270 will flow out of the siphon 290 until the level of the diluent 110 within the dispensing compartment 270 falls below the suction bell 300 so as to break the suction therein. Other configurations and other components may be used herein. The given volume 355 of the diluent 110 thus may be dispensed in a repeatable fashion.

Referring again to FIG. 1, the dispensing system 100 also includes one or more concentrate control subsystems 400. The concentrate control subsystems 400 provide a known volume of the concentrate 120 to produce the beverage 130. Each concentrate control subsystem 400 may include a concentrate source 410. The concentrate source 410 may be a vented, substantially rigid container, a non-vented bag in box type container, a refillable carafe, and the like. Any type or configuration of the concentrate source 410 may be used herein. Any number of concentrate sources 410 may be used.

The concentrate control subsystem 400 may include a volumetric dosing chamber 420. The volumetric dosing chamber 420 may have any desired size, shape or volume so as to provide a desired dose 425 of the concentrate 120. The volumetric dosing chamber 420 may be at atmospheric pressure. The volumetric dosing chamber 420 may be in communication with the concentrate source 410 via an incoming concentrate line 430. The incoming concentrate line 430 may be any type of conduit. An incoming concentrate valve 440 may be positioned on the incoming concentrate line 430. The incoming concentrate valve 440 may be any type of open and close valve. The incoming concentrate valve 440 may be operated by a solenoid 450 or any other type of actuating device. The solenoid 450 may be in communication with the controller 180. Other configurations and other components may be used herein.

An adjustable vent tube 460 may be positioned within the volumetric dosing chamber 420. The position of the adjustable vent tube 460 may be varied via a positioning device 470. The positioning device 470 may be any type of thumb wheel, lever, or other device to raise or lower the adjustable vent tube 460 within the volumetric dosing chamber 420. A first end 480 of the adjustable vent tube 460 may be within the volumetric dosing chamber 420 at the desired level while a second end 490 may extend to or above the height of the concentrate source 410. Other configurations and other components may be used herein.

An outgoing concentrate line 500 may extend from a bottom 510 of the volumetric dosing chamber 420. The outgoing concentrate line 500 may be any type of conduit. The outgoing concentrate line 500 may have an outgoing concentrate valve 520 positioned thereon. The outgoing concentrate valve 520 may be any type of open and close valve. The outgoing concentrate valve 520 may be operated by a solenoid 530 or other type of actuating device. The solenoid 530 may be in communication with the controller 180. The outgoing concentrate line 500 may extend from the bottom 510 of the volumetric doing chamber 420 to a dispensing end 540 thereof. The dispensing end 540 may be located adjacent to the dispensing end 310 of the siphon 290 of the diluent control subsystem 200 or otherwise. Other configurations and other controls may be used herein.

In use, the concentrate control subsystem 420 provides the concentrate dose 425 in an efficient, repeatable, and accurate manner. The controller 180 opens the incoming concentrate valve 440 via the solenoid 450 such that the concentrate 120 flows through the incoming concentrate line 430 and into the volumetric dosing chamber 420 under the force of gravity. Air within the volumetric dosing chamber 420 may be vented through the adjustable vent tube 460 until the level of the concentrate 120 reaches the mouth or the first end 480 of the vent tube 460. The remaining trapped volume of air within the volumetric dosing chamber 420 then prevents any further concentrate 120 from flowing into the volumetric dosing chamber 420. Moreover, siphoning of the concentrate 120 through the vent tube 460 may be prevented by the vent tube 460 extending to the height of the fluid level within the concentrate source 410. The incoming concentrate valve 440 may be closed by the controller 180 based upon an elapsed time or other parameter. Nonetheless, only the desired volume of the concentrate 120 will fill the volumetric dosing chamber 420 regardless of whether the incoming concentrate valve 440 is opened or closed. The volume of the concentrate dose 425 within the volumetric dosing chamber 420 may be varied by raising or lowering the adjustable vent tube 460 via the positioning device 470.

When a dose 425 of the concentrate 120 is desired to produce the beverage 130, the controller 180 opens the outgoing concentrate valve 520. The dose 425 of concentrate 120 therein then flows through the outgoing concentrate line 500 and through the dispensing end 540. The outgoing concentrate valve 520 then may be closed by the controller 180 based upon an elapsed time or other parameter. Other configurations and other components may be used herein.

The dispensing system 100 as a whole also may include a selection device 600. The selection device 600 may be a touch screen, a number of pushbuttons, or any type of input device. The selection device 600 may be in communication with the controller 180. A consumer may interact with the selection device 600 to select the desired beverage 130 such as the coffee beverage 160, the tea beverage 170, and the like. The consumer also may select the desired size of the beverage 130 and desired additives such as cream, sugar, and the like. The consumer also may select any desired intensity of the beverage 130. (Varying the size and intensity of the beverage 130 may require internal configuration changes and/or multiple doses.) The consumer may select the intensity via the selection device 600. The controller 180 may then communicate with the positioning device 470 of the adjustable vent tube 460. Alternatively, the consumer may mechanically adjust the positioning device 470 so as to set the intensity level. Other types of consumer input may be used herein.

In use, the dispensing system 100 preferably starts in a charged position. That is, the diluent control subsystem 200 fills the diluent tank 220 under the force of gravity or otherwise with the diluent 110 via, the diluent valve 250 until the fluid level reaches the first sensor 330. The diluent 110 therein then may be heated via the immersion heater 360 to the desired temperature.

Likewise, the concentrate control subsystem 400, or each of them, fills the volumetric dosing chambers 420 with the desire dose 425 of the concentrate 120 by opening the incoming concentrate line 430 such that the appropriate dose 425 of the concentrate 120 flows into each volumetric dosing chamber 420 under the force of gravity until the first end 480 of the adjustable vent tube 460 is reached. The incoming concentrate valve 440 may be closed by the controller 180 based upon an elapsed amount of time or other parameter.

In the charged position, the diluent control subsystem 200 thus has a large volume of heated diluent 110 while the concentrate control subsystems 400 have a number of concentrate doses 425 ready to dispense. In this example, the coffee concentrate 140 and the tea concentrate 150 may be loaded. Any type of concentrate 120 or other additive may be used herein.

The consumer then may select the desired beverage 130 via the selection device 600 or other type of input device. Likewise, the intensity of the beverage 130 also may be selected. The controller 180 then opens the diluent valve 250 such that the given volume 355 of diluent 110 flows into the diluent tank 220. This additional volume of the diluent 110 thus fills the dispensing compartment 270 with the warmed diluent 110. The cooler incoming diluent 110 enters about the bottom 240 of the dispensing tank 220. The dispensing tank 220 may be large enough so as to provide temperature capacitance. In other words, the diluent 110 in the fluid tank 220 holds enough heat such that the incoming diluent 110 heats up to the desired temperature almost immediately. Once the diluent level 110 reaches the second sensor 350, the controller 180 closes the diluent valve 250. The diluent level is then at about the top bend 275 of the siphon 290 such that the given volume 355 of the diluent 110 flows through the siphon 290 and the dispensing end 310 under the force of gravity.

The controller 180 also opens the outgoing concentrate valve 520 of the selected concentrate control subsystem 400 once the diluent level within the diluent tank 220 reaches the second sensor 350. A timing delay also may be used herein. The dose 425 of the concentrate 120 within the volumetric dosing chamber 420 thus flows through the outgoing concentrate line 500 and the dispensing end 540. The controller 180 may close the outgoing concentrate valve 520 after a given elapsed time or other parameter. A receptacle 610 may be positioned about the dispensing end 310 of the siphon 290 and the dispensing end 540 of the outgoing concentrate line 500 to receive the flow of the diluent 110 and the concentrate 120. The diluent 110 and the concentrate 120 may mix within the receptacle 610 so as to form the beverage 130. A mixing nozzle or other type of mixing compartment also may be used herein.

Because the dispensing system 100 uses the given volume 355 of the dispensing compartment 270 within the diluent tank 220 of the diluent control subsystem 200 and the adjustable volume within the volumetric dosing chamber 420 of the concentrate control subsystem 400, accurate and repeatable beverages 130 may be consistently provided. Multiple beverages 130 also may be provided in a short recycle time given the use of the diluent tank 220.

Moreover, the dispensing system 100 includes a simplified control system. Specifically, the controller 180 merely needs to operate the solenoids of the diluent valve 250, the incoming concentrate valve 440, and the outgoing concentrate valve 520. The on/off decisions may be made via an elapsed time, the input from the level sensors 320, or other parameters. Pump and flow control decisions thus may be avoided. Likewise, the pumps themselves may be avoided given the use of the gravity flow systems described herein.

The dispensing system 100 thus provides an efficient and low cost alternative to known beverage dispensers. The use of gravity and other types of hydraulic flow controls with limited and simplified electronic controls provides the dispensing system 100 described herein with these advantages and ensures precise ratio and proportion control.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

I claim:

1. A dispensing system for mixing a first fluid and a second fluid, comprising:
a first fluid source with the first fluid therein;
a volumetric dosing chamber in communication with the first fluid source;
a vent tube extending from within the volumetric dosing chamber to about the first fluid source;
wherein a dose of the first fluid from the first fluid source flows into the volumetric dosing, chamber under the force of gravity until the first fluid reaches the vent tube;
a first fluid dispensing line in communication with the volumetric dosing chamber;
a second fluid source with the second fluid therein; and
a second fluid dispensing line in communication with the second fluid source;
wherein the dose of the first fluid may flow through the first fluid dispensing line and the second fluid may flow through the second fluid dispensing line.

2. The dispensing system of claim 1, wherein the first fluid source is in communication with the volumetric dosing chamber via an incoming line.

3. The dispensing system of claim 2, wherein the incoming line comprises an incoming valve thereon.

4. The dispensing system of claim 3, further comprising a solenoid or other actuating device operating the incoming valve.

5. The dispensing system of claim 1, wherein the vent tube comprises an adjustable height vent tube.

6. The dispensing system of claim 1, wherein the first fluid dispensing line comprises an outgoing valve thereon.

7. The dispensing system of claim 6, further comprising a solenoid or other actuating device operating the outgoing valve.

8. The dispensing system of claim 1, wherein the second fluid dispensing line comprises a siphon.

9. The dispensing system of claim 8, further comprising a fluid tank in communication with the second fluid source and the siphon.

10. The dispensing system of claim 9, wherein the fluid tank comprises a dispensing compartment with the siphon therein.

11. The dispensing system of claim 10, wherein the fluid tank comprises one or more level sensors therein.

12. The dispensing system of claim 11, wherein the one or more of level sensors comprise a dispensing sensor just above a top bend of the siphon such that the second fluid within the dispensing compartment flows through the siphon under the force of gravity when the second fluid reaches the dispensing sensor.

13. The dispensing system of claim 8, wherein the siphon comprises a suction bell thereon.

14. The dispensing system of claim 9, wherein the second fluid source is in communication with the fluid tank via an incoming line with an incoming valve thereon.

15. A method of mixing a first fluid and a second fluid under the force of gravity, comprising:
flowing a dose of the first fluid into a volumetric dosing chamber under the force of gravity until the first fluid reaches a vent tube therein;
flowing a volume of the second fluid into a fluid tank under the force of gravity until the second fluid reaches a top bend of a siphon therein;
flowing the dose of the first fluid through a first fluid line under the force of gravity into a receptacle; and
flowing the volume of the second fluid through the siphon under the force of gravity into the receptacle.

16. A dispensing system for mixing a concentrate and a diluent, comprising:
a concentrate source with concentrate therein;
a volumetric dosing chamber in communication with the concentrate source;
a vent tube extending from within the volumetric dosing chamber to about the concentrate source;
wherein a dose of the concentrate from the concentrate source flows into the volumetric dosing chamber under the force of gravity until the concentrate reaches the vent tube;
a concentrate dispensing line in communication with the volumetric dosing chamber;
a diluent tank with a volume of the diluent therein; and
a siphon in communication with the diluent tank;
wherein the dose of the concentrate may flow through the concentrate dispensing line and the volume of the diluent may flow through the siphon.

17. The dispensing system of claim 16, wherein the vent tube comprises an adjustable height vent tube.

18. The dispensing system of claim 16, wherein the diluent tank comprises a dispensing compartment with the siphon therein.

19. The dispensing system of claim 16, wherein the diluent tank comprises a dispensing sensor just above a top bend of the siphon such that the volume of the diluent within the dispensing compartment flows through the siphon under the force of gravity when the diluent reaches the dispensing sensor.

20. The dispensing system of claim 16, wherein the siphon comprises a suction bell thereon.
